(19) United States
(12) Patent Application Publication
(10) Pub. No.: US 2016/0057981 A1
(43) Pub. Date: Mar. 3, 2016

(54) Fish Hook And Interconnection Device That Break At A Controlled Force

(71) Applicants: William John Beecher, Aptos, CA (US); Courtney Leroy Hart, Berthoud, CO (US)

(72) Inventors: William John Beecher, Aptos, CA (US); Courtney Leroy Hart, Berthoud, CO (US)

(21) Appl. No.: 14/476,111

(22) Filed: Sep. 3, 2014

(51) Int. Cl. A01K 83/00

(52) U.S. Cl. CPC A01K 83/00

(57) ABSTRACT

Fishermen lose their fishing gear when they hook onto an obstruction. This invention minimizes the loss of the gear. The hook is the last element on most fishing lines. Having it fail first can save the rest of the gear.

This invention selectively reduces the cross section of the shaft or the eyelet of the hook or the split ring connecting device. Using the strength of the materials, appropriate yield strengths can be calculated for either tensile or shear breakage.

Reducing the overall cross section of the fish hook will cause the hook to straighten out when a fish strikes the hook. Reducing selectively the cross section of the shaft or the eyelet or the split ring maintains the strength of the hooking area while providing a lower breakage point for the overall hook.

### BACKGROUND OF THE INVENTION

(a) Field of the Invention

This invention relates to a fishing hook which will break from an obstacle at a chosen force or to a split ring connection device that will either straighten out or break at a given force.

(b) Description of the Prior Art

There are many patents with the same intent, but using different means to achieve the same result. They use an additional device that can be adjusted to release the fishing hook at a given force. These patents are:

U.S. Pat. No. 3,210,883 patented Oct. 12, 1965 by G. Ulsh provides a device for releasing fish hooks from the fishing line or artificial bait such as, a plug or spoon as the case may be. It provides an anchor that will release the hook when it gets caught in some foreign object while fishing for saving the line and bait after a predetermined pull on the line.

U.S. Pat. No. 3,518,784 patented Jul. 7, 1970 by E. A. Kling provides a releasable fish-hook assembly is provided herein. The assembly includes a hollow, double-open-ended cylindrical retainer. A fish-hook is modified to have an arrowhead, which may or may not be deformable, which is attached thereto, the arrowhead being capable of passing through the central core of the hollow cylindrical retainer in one direction only. Connecting means are provided which connect the fish-hook to the arrowhead, such means being adapted to break to release the arrowhead from the fish-hook when a force on the fish-hook exceeds a pre-set limit.

U.S. Pat. No. 3,648,399 patented Mar. 14, 1972 by K. R. Lloyd provides a device for releasing a fish hook from a fishing line when engaged with a fixed object in the water, without loss of any portion of the fishing equipment other than the fish hook itself.

U.S. Pat. No. 3,688,434 patented Sep. 5, 1972 by Vau Walter H Le provides a snagless fishing lure or sinker having a smoothly curved wire bail embedded in an extending from the body of the lure or sinker near the front and rear ends thereof to form front and rear notches with the body at the bail's points of entry. A fishing swivel, attachable to a fishing line or leader, is slidably mounted on the bail for smoothly sliding movement between front and rear notches, the swivel nesting at the front notch to define a normal trolling position wherein the swivel contacts the body. In response to a forward pull on the line or leader, the front end of the body rises thereby avoiding snagging of the body as the body moves forward through the water. If the front end of the body wedges in a snag and thereby tensions the fishing line, line tension exerts a force on the body which causes the rear end of the body to rise sliding the swivel rearwardly along the bail and rotating the body and nesting the swivel at the rear notch so the snagged body can be pulled out of the snag.

U.S. Pat. No. 4,125,958 patented Nov. 21, 1978 by Bernard Cote provided a coupling assembly adapted to connect a fishhook to the remainder of a fishing line, including the lure, and which responds to tension on this remainder of the fishing line to release the same free of the fishhook when the latter catches a submerged obstacle. This tension release coupling assembly includes a resilient coupling member, such as of plastic, which is attached to the cord of the fishing line and which has a cavity therein adapted to releasably catch the eye of a common fishhook or an enlarged end portion of a specially made fishhook or hook connector member. The resilient coupling member may be calibrated in relation to the different strengths of cord used for the fishing lines such that the fishhook will be released before the tensional strength of the corresponding cord is reached. The resilient coupling members are colored in accordance with a code distinctive of the predetermined calibration of strength thereof.

U.S. Pat. No. 4,848,018 filed Oct. 31, 1988 by John F Clarke provided a releasable fish-hook assembly is provided herein. The assembly includes a hollow, double-open-ended cylindrical retainer. A fish-hook is modified to have an arrowhead, which may or may not be deformable, which is attached thereto, the arrowhead being capable of passing through the central core of the hollow cylindrical retainer in one direction only. Connecting means are provided which connect the fish-hook to the arrowhead, such means being adapted to break to release the arrowhead from the fish-hook when a force on the fish-hook exceeds a pre-set limit.

U.S. Pat. No. 5,076,006 filed Nov. 26, 1990 by Gredo W Kahng provided an elongated fishing connector constructed from a plastic material molded or cast upon metal terminal members where the terminal metal terminal members can be molded or cast into the ends of the connector. The connector is separable or breakable in a mid section at a predetermined force to allow severance prior to reaching the breaking strength of the fishing line. Alternately, a terminal member is separable from the connector body at a predetermined force. A breakable line can be utilized internally in the connector body.

Canadian Pat. No. 381,250 patented May 9, 1939 by B. Whitis provided a fish-hook releasing device including a hook having a rigid shank, and means interposed between the hook shank and line to jar the hook loose from any obstruction on which it may be caught in casting. Such means included a member having a single universal connection with the shank at the end remote from the hook and a light plunger connected with the rod at the opposite end. A body member was formed with an internal bore traversed by the plunger and closed at its opposite ends. The plunger rod slide ably passed through one of the open ends of the body member. A compression spring was disposed in the bore in surrounding relation to the plunger rod, with one end bearing on the plunger and the other end bearing on that extremity of the bore through which the rod passed. Means were provided for connecting the line to the body member at the opposite end from the plunger rod. Upon engagement of the hook with an obstruction, a pull on the line may retract the body member so that on quick release of the line it may engage the plunger with a sudden impact to dislodge the hook.

Canadian Pat. No. 505,074 issued Aug. 17, 1954 to E. P. Cox provided a device for disengaging fish-hooks. The patented device included a frame having means enabling the device to travel along a line attached to a caught fish-hook or to another caught object. A hammer mechanism was mounted on the frame for movement from a retracted position to a projected position and vice versa. Resilient means was provided for continually urging the hammer mechanism to the projected position. A latch mechanism was also employed for holding the hammer mechanism in retracted position against the action of the resilient means. When the device was mounted on the fish line, the latch mechanism was set to hold the hammer mechanism in retracted position. When the device contacted the caught fish-hook, automatic means was actuated to release the latch mechanism and thereby to effect projection of the hammer mechanism by the resilient means. Projection of the hammer mechanism resulted in its striking the caught fish-hook, and this resulted in effecting release of the fish-hook.

Canadian Pat. No. 587,043 issued Nov. 17, 1959 to N. L. Cook provided a fish-hook release. The patented fish-hook release included a connecting device which included a longitudinally-bored body. An end portion of the line was slidable through the bore in the body and was operatively connected to a collar which was slidable on the body toward and from a second collar also carried by the body and which was resisted by a coil spring which was normally expanded and surrounded the body between the collars. The end of the body which was adapted to accommodate the shank of the fish-hook was provided with a pair of cooperating jaws, one stationary and the other movable. The jaws were maintained normally closed by the encircling spring biased collar.

Canadian Pat. No. 1,111,249 issued Oct. 27, 1981 to Bernard Cote provided a tension release coupling from a fish-hook. The patented coupling assembly included a resilient coupling member attachable to the fish line and a connector member which is part of the fish-hook assembly and releasable coupling with the coupling member. The coupling member consisted of a one piece body of resilient plastic and non-compressible material, the body being elongated, having opposite sides and two opposite ends, and having a slot extending longitudinally thereof from one end towards but short of the other end, the slot opening at the opposite sides and at the one end and defining two elongated arms spaced from each other and integrally interconnected by a transverse bight portion at the other end and having an intermediate cavity. The connector member included an enlarged head removably insertable into the slot, the movement continuing until the head fully engaged the cavity, the head having an external surface complementary to the shape of the cavity.

### SUMMARY OF THE INVENTION

(a) Aims of the Invention

Even though these patented devices meet the objective of releasing the line or lure from the obstruction, they add complexity. A principle objective of this invention is to eliminate this complexity by altering the fishing hook to yield at a force less than that which would break the fishing line, and which does not affect the curved area of the fishing hook from straightening out. Alternately, the split ring connection device can be constructed in such a way as to yield at a force less than that which would break the fishing line.

(b) Statements of Invention

By this invention a fishing lure or fishing line will break free from an obstacle when the reduced cross section of the fishing hook's shaft or fishing hook's eyelet or split ring connection device breaks at a force less than that needed to break the fishing line.

(c) Further Features of the Invention

For multi-pronged fishing hooks, such as a double or triple hook arrangement, it is convenient to reduce the cross section of the eyelet region to include the shank area just below the eyelet in such a way that either the reduced shank cross section or the eyelet breaks.

### BRIEF DESCRIPTION OF THE DRAWINGS

In the accompanying drawings,

FIG. 1 is a single hook fishing hook with the eyelet of the fishing hook reduced in cross section;

FIG. 2 is a single hook fishing hook with the shaft of the fishing hook reduced in cross section;

FIG. 3 is a single hook fishing hook with the eyelet and the upper part of the shaft of the fishing hook reduced in cross section;

FIG. 4 is a double hook fishing hook with the eyelet and the upper part of the shaft of the fishing hook reduced in cross section;

FIG. 5 is a double hook fishing hook with the eyelet and the upper part of the shaft of the fishing hook reduced in cross section and with one loop for the eyelet;

FIG. 6 is a single loop, split ring connecting device between the fishing hook eyelet and the lure;

FIG. 7 is a multi-loop, split ring connecting device between the fishing hook eyelet and the lure;

FIG. 8 is a fishing hook with a split ring attached through the eyelet; and

FIG. 9 is a split ring with one end extended away from the ring to facilitate attaching the split ring to the fishing hook and/or the lure.

### DESCRIPTION OF PREFERRED EMBODIMENTS

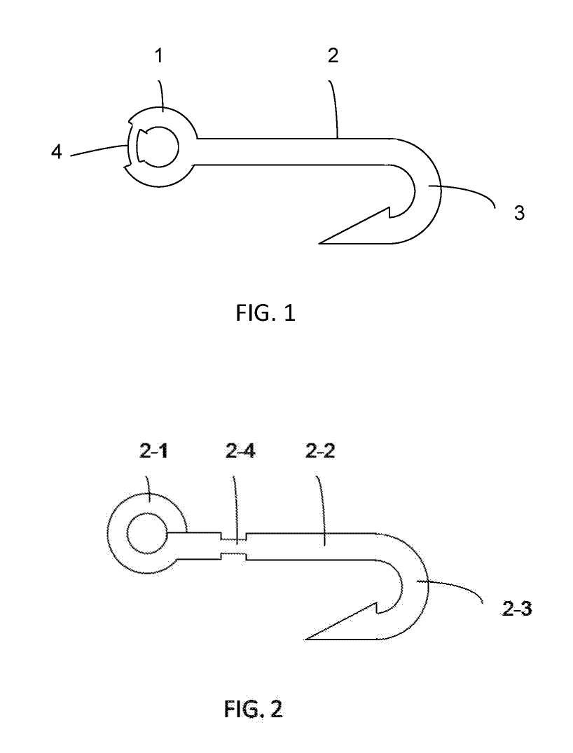

(a) Description of FIG. 1

As seen in FIG. 1, the fishing hook eyelet has been reduced in cross section so the eyelet will break or shear at a prescribed force.

(b) Description of FIG. 2

The second embodiment of the invention as seen in FIG. 2 reduces the shaft cross section so it will break at a prescribed tensile force.

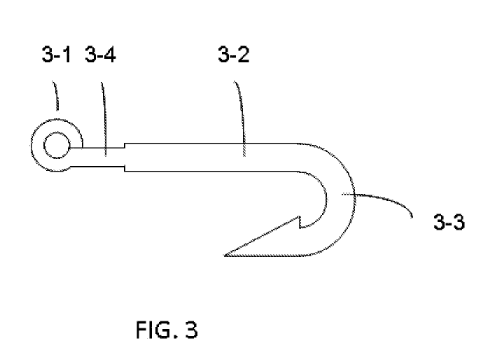

(c) Description of FIG. 3

The third embodiment of the invention as seen in FIG. 3 is similar in most respects to both the first and second embodiments in that it utilizes both concepts to reduce the eyelet and upper shaft cross sections. This might aid in the manufacturing of the fishing hook.

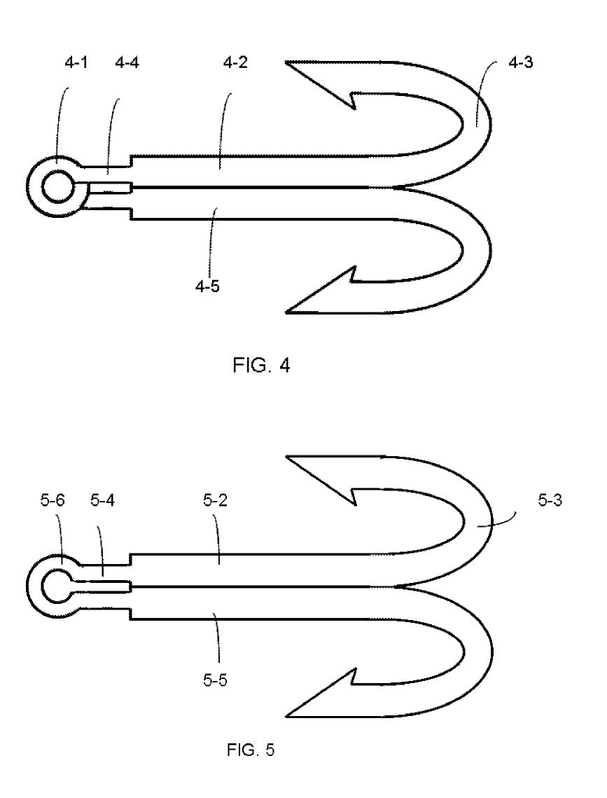

(d) Description of FIG. 4

The fourth embodiment of this invention as seen in FIG. 4 is similar in most respects to FIG. 3 except that it has two hooks instead of one.

(e) Description of FIG. 5

The fifth embodiment of this invention as seen in FIG. 5 is similar to FIG. 4 except that there is a single loop for the eyelet. The cross section of this reduced area can break from the shear force in the eyelet or from the two shafts from tensile force, depending on the material properties of the fishing hook.

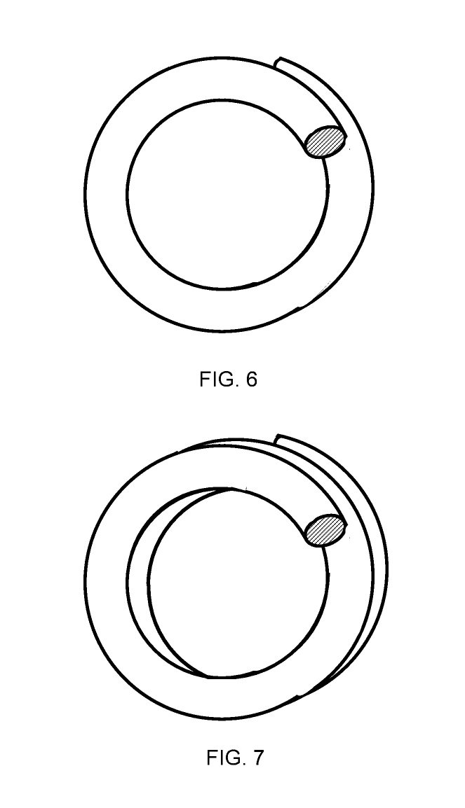

(f) Description of FIG. 6

The sixth embodiment this invention as seen in FIG. 6 is a single loop, split ring connecting device between the fishing hook eyelet and the lure. The cross section of the split ring is reduce so as to either break at a prescribed force or will allow the split ring to straighten out, thus releasing the lure from the fishing hook.

(g) Description of FIG. 7

The seventh embodiment of this invention as seen in FIG. 7 is a multi-loop, split ring connecting device between the fishing hook eyelet and the lure. The cross section of the split ring is reduced to break at a prescribed force. Implementing the reduction of the eyelet shown in FIG. 1 can also be done to the split ring to achieve the desired results.

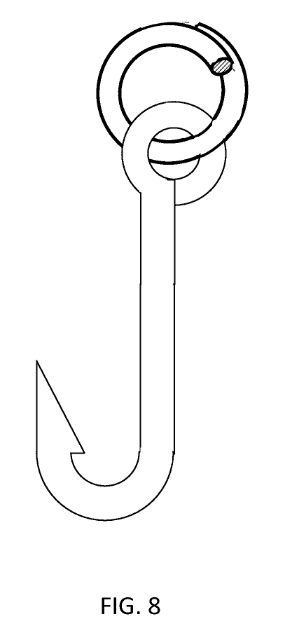

(h) Description of FIG. 8

The eighth embodiment of this invention as seen in FIG. 8 is a split ring attached through the eyelet of the fishing hook.

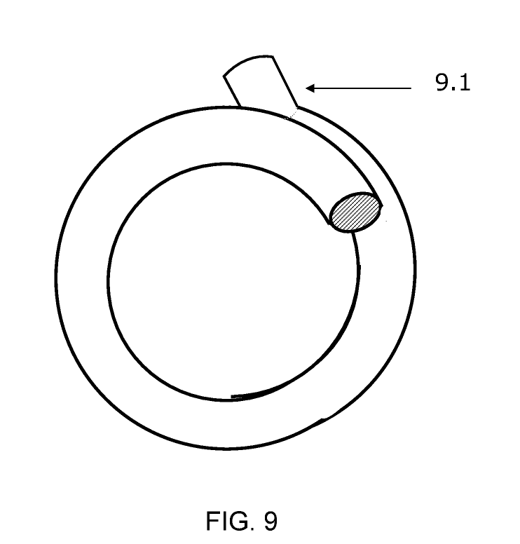

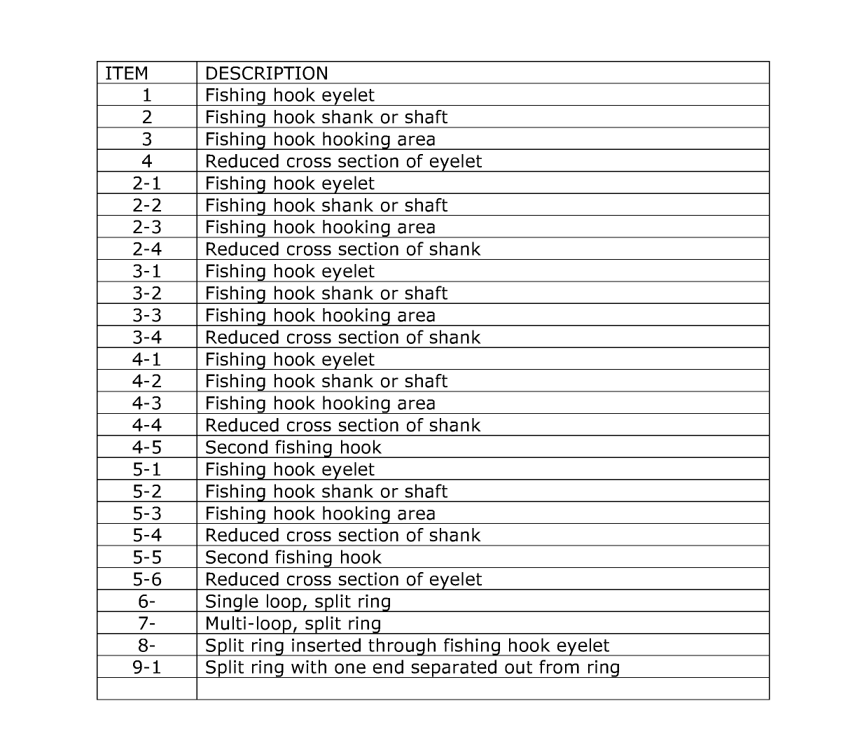

(i) Description of FIG. 9

The ninth embodiment of this invention as seen in FIG. 9 is a split ring with one end extended away from the ring to facilitate attaching the split ring to the fishing hook and/or the lure.

### OPERATION OF EMBODIMENTS OF INVENTION

(a) Operation of the First, Third Embodiment shown in FIG. 1

Reduction of the cross section of the eyelet of the fishing hook permits the eyelet to break at a lower force. The yield point of the eyelet can be determined from the material properties of the fishing hook and the cross sectional area. This is set at a yield point less than the tensile breaking force of the fishing line or leader.

Reducing the entire fishing hook diameter may cause the fish hooking area to straighten when struck by a fish. This is an unwanted outcome.

(b) Operation of the Third, Fourth and Fifth Embodiments shown in FIGS. 3, 4 and 5

Reduction of the cross section of the eyelet of the fishing hook permits the eyelet to break at a lower force. The yield point of the eyelet can be determined from the material properties of the fishing hook and the cross sectional area. This is set at a yield point less than the tensile breaking force of the fishing line or leader.

This is similar to the First Embodiment except that the entire eyelet cross section has been reduced. This can simplify the manufacturing of the fishing hook.

Reducing the entire fishing hook diameter may cause the fish hooking area to straighten when struck by a fish. This is an unwanted outcome.

(c) Operation of the Second, Third, Fourth and Fifth Embodiments shown in FIGS. 2, 3, 4 and 5

Reduction of the cross section of the fishing hook shaft permits the shaft to break from a determined tensile force. This is set at a yield point less than the tensile breaking force of the fishing line or leader.

Reducing the entire fishing hook diameter may cause the fish hooking area to straighten when struck by a fish. This is an unwanted outcome.

(d) Operation of the Fourth and Fifth Embodiments shown in FIGS. 4 and 5

The Fourth and Fifth Embodiments are for a dual hook fishing hook. The principles also apply to triple and more hooks. Reducing both the eyelet and the shaft cross sections permits the fishing hook to break either from shear forces at the top of the eyelet or from tensile forces along the shaft. The Fifth Embodiment simplifies the manufacturing of the fishing hook.

Reducing the entire fishing hook diameter may cause the fish hooking area to straighten when struck by a fish. This is an unwanted outcome.

(e) Operation of the Sixth Embodiment Shown in FIG. 6

Reduction of the cross section of the single loop, split ring connecting device permits the split ring to either straighten out or to break. The yield point of the split ring can be determined from the material properties of the split ring and the cross sectional area. This is set at a yield point less than the tensile breaking force of the fishing line or leader.

(f) Operation of the Seventh Embodiment Shown in FIG. 7

Reduction of the cross section of the multi-loop, split ring connecting device permits the split ring to break. The yield point of the split ring can be determined from the material properties of the split ring and the cross sectional area. This is set at a yield point less than the tensile breaking force of the fishing line or leader.

Selective reduction of the multi-loop, split ring, as described for the First Embodiment, can achieve the same results as described for the First Embodiment.

(g) Operation of the Ninth Embodiment Shown in FIG. 9

Diverting one end of the split ring away from the body of the ring allows easier engagement of the split ring with the fishing hook eyelet or to a lure.

### CONCLUSION

From the description above, one skilled in the art can understand the principles of this invention, and without departing from the spirit and scope described above, can make changes and modifications of this invention to meet different needs and conditions. Any changes and modifications are within the full range of the claims.

What we claim is:

1. A fishing hook comprising
(a) the shaft of the fishing hook selectively reduced in cross section to break at a given force.
(b) the eyelet of the fishing hook selectively reduced in cross section to break at a given force.

2. A split ring connection device between the fishing hook and the lure or other device comprising
(a) a single loop reduced in cross section to break at a given force or to straighten out.
(b) a multi-loop reduced in cross section to break at a given force.
(c) a multi-loop selectively reduced in cross section to break at a given force.
(d) A split ring with one end jutting out from the ring in order to allow easier use.
